(19) United States
(12) Patent Application Publication
(10) Pub. No.: US 2002/0194129 A1
(43) Pub. Date: Dec. 19, 2002

(54) IC card reader/writer

(75) Inventors: Jun Furuya, Tokyo (JP); Kenji Matsumoto, Yokohama-shi (JP); Kazuhiro Kawashima, Yokohama-shi (JP); Masaru Ohki, Tokorozawa-shi (JP); Atsushi Ito, Tokyo (JP); Haruko Nagaoka, Kawasaki-shi (JP)

Correspondence Address: MATTINGLY, STANGER & MALUR, P.C., 1800 DIAGONAL ROAD, SUITE 370, ALEXANDRIA, VA, 22314, US

(73) Assignee: Hitachi, Ltd.

(21) Appl. No.: 10/214,117

(22) Filed: Aug. 8, 2002

Related U.S. Application Data
(63) Continuation of application No. 09/269,941, filed on Apr. 8, 1999.
Application No. 09/269,941 is a 371 of international application No. PCT/JP96/02936, filed on Oct. 9, 1996.

(51) Int. Cl. G06F 17/60

(52) U.S. Cl. 705/41

(57) ABSTRACT

The present invention provides an IC card reader/writer and a method of operation thereof. The IC card reader/writer comprises a body 101 having an insertion hole 112 for inserting an IC card and an input unit 114 for inputting an amount, and a docking station 28 separated from the body 101 and capable of transferring the electronic currency through a communication line when the body 101 is set in the docking station. The body 101 can be used portably by seperating it from the docking station 28 or, the body 101, when set in the docking station, can carry out electronic currency transactions with other electronic currency holding means through a communication line.

### TECHNICAL FIELD

The present invention relates to a reader/writer for the electronic currency used in an electronic currency system and a method of operation thereof, and more in particular to a portable reader/writer and a method of operation thereof.

### BACKGROUND ART

In recent years, an electronic currency system has been proposed for conducting transactions in electronic currency by communication between IC cards containing electronic currency. The IC card used for this system contains therein a microprocessor having the communication function and a memory such as an EEPROM for storing a processing program and the outstanding amount of the electronic currency. The IC card permits the electronic currency to be deposited and withdrawn into and from other IC cards, through an electronic currency system in which terminals installed in banks, shops and individual homes can be connected arbitrarily through a communication line, or by use of an electronic purse IC card providing an exclusive terminal.

The conventionally proposed IC card read/write terminal connected to the communication line is installed in banks, shops and individual homes and is not easy to carry. It is difficult to use it at various points in a shop or carry and use it out of shops or while moving in a transportation means or the like. The electronic purse, on the other hand, though portable and usable for the electronic currency transactions between IC cards, is not connected with the communication line and therefore impossible to use for the electronic currency transactions with an IC card at a distant point.

The object of the present invention is to provide a portable POS terminal for the electronic currency which is used in the electronic currency system described above and which is capable of communication through a public telephone network, and a method of operation thereof.

### DISCLOSURE OF INVENTION

According to the present invention, an electronic currency IC card reader/writer for transferring the electronic currency held in an IC card comprises a body having an insertion hole for inserting the IC card and buttons for inputting an amount, and a station separate from the body, which with the body set therein, is adapted for transferring the electronic currency through a communication line. Once the body is separated from the station, it can be carried and used. In the case where the body is set in the station, on the other hand, the electronic currency transactions can be conducted with other IC cards or electronic currency holding means located at a distant place through the communication line.

Also, according to this invention, an IC card reader/writer for transferring the electronic currency held in an IC card comprises a body having an insertion hole for inserting an IC card and buttons for inputting an amount, an IC card read/write unit having an insertion hole for inserting the IC card, and a station separate from the body, which with the body set therein, can transfer the electronic currency through the communication line. The IC card read/write unit separated from the body can be easily operated by the customer, for example, for the payment of the electronic currency. The operation by the customer himself/herself alleviates his/her anxiety he/she may have about the use of the electronic currency and improves the reliability of the electronic currency.

Also, according to the present invention, an IC card reader/writer for transferring the electronic currency held in an IC card comprises an insertion hole for inserting the IC card and buttons for inputting an amount, is usable in separation from a station connected with a communication line, and when set in the station, can transfer the electronic currency through the communication line. As a result, the IC card reader/writer can be carried and used for transactions of electronic currency between the IC cards without the communication line, while the station is set therein only when conducting the electronic currency transactions through the communication line.

Also, according to this invention, a method of operating an IC card reader/writer for transferring the electronic currency held in an IC card comprises the steps of inputting an amount from the body of the IC card reader/writer, displaying the amount on the IC card read/write unit communicable with the body and separated from the body, and inserting the IC card in the IC card insertion hole of the IC card read/write unit. This makes it easy for the customer paying the electronic currency, for example, to check and operate the IC card read/write unit separated from the body. Since the customer can insert the IC card while checking the amount, the anxiety on the part of the customer about using the electronic currency is alleviated and the reliability of the electronic currency can be improved.

Also, according to this invention, a method of operating an IC card reader/writer for transferring the electronic currency held in an IC card comprises the steps of setting the body of the IC card reader/writer in a separate station whereby the body is set in the station capable of transferring the electronic currency through a communication line, and displaying the amount remitted from the IC card inserted in the body to another IC card inserted in the station, or to other electronic currency holding means for transferring the electronic currency through the communication line. When the transfer of the electronic currency is desired through a communication line, the body is set in the station, and the amount remitted can be checked. Therefore, the erroneous operation for remittance can be prevented.

### BRIEF DESCRIPTION OF DRAWINGS

FIG. 1 is a block diagram showing a configuration of an electronic currency system using an IC card reader/writer according to this invention; FIGS. 2 to 4 are perspective views showing the outer appearance of a portable money transfer terminal according to an embodiment of this invention; FIG. 5 is a sectional view showing the portable money transfer terminal set in a docking station according to an embodiment of the invention; FIG. 6 is a diagram showing a display unit and an input unit of the portable money transfer terminal according to an embodiment of this invention; FIGS. 7 and 8 are diagrams showing the manner in which the portable money transfer terminal according to an embodiment of this invention is used in a shop; FIGS. 9 to 11 are block diagrams showing a functional configuration of the portable transfer terminal and the docking station; FIGS. 12 to 14 are flowcharts of electronic currency transactions conducted between IC cards using the portable money transfer terminal according to an embodiment of the invention; and FIG. 15 is a flowchart of unlocking the IC card according to an embodiment of this invention. Also, FIG. 16 is a diagram showing the manner in which the portable money transfer terminal according to an embodiment of the invention is used in a taxi; FIG. 17 is a block diagram showing a functional configuration of the portable money transfer terminal, a customer IC card reader/writer and a taxi meter; and FIG. 18 is a flowchart of the electronic currency transactions conducted between IC cards using the portable transfer terminal according to an embodiment of the invention.

### BEST MODE FOR CARRYING OUT THE INVENTION

An embodiment of an IC card reader/writer for an electronic currency system according to this invention will be explained in detail below with reference to the drawings.

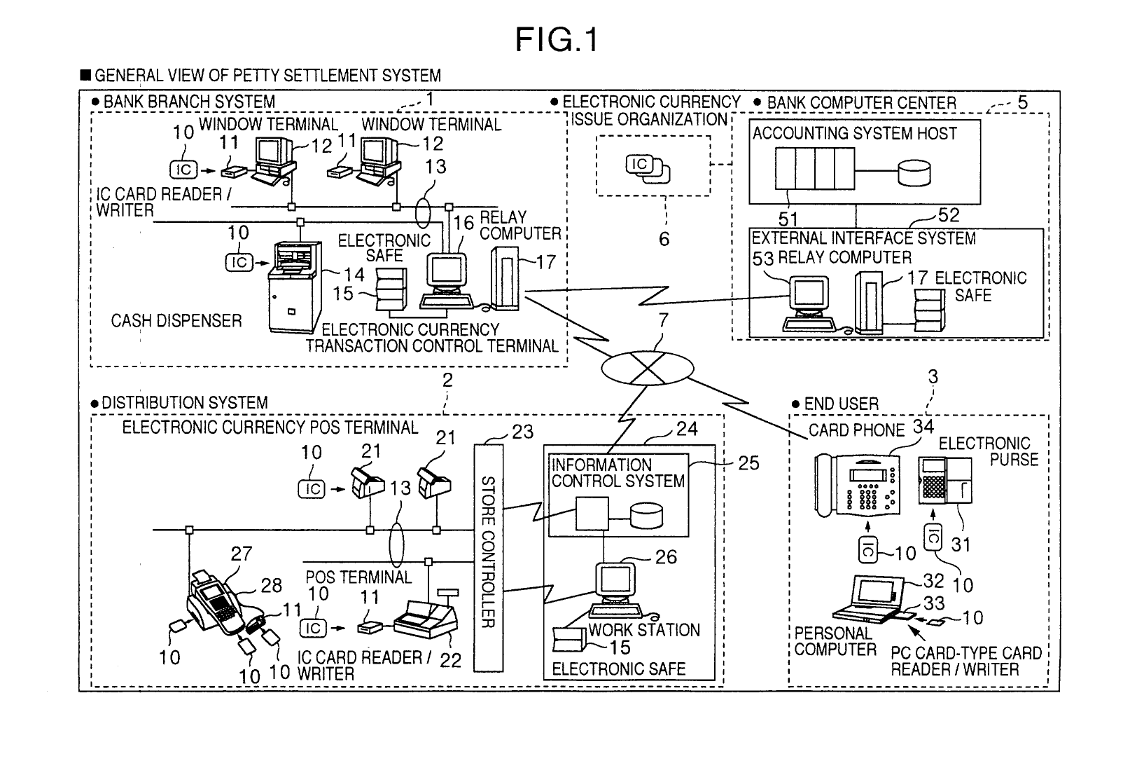

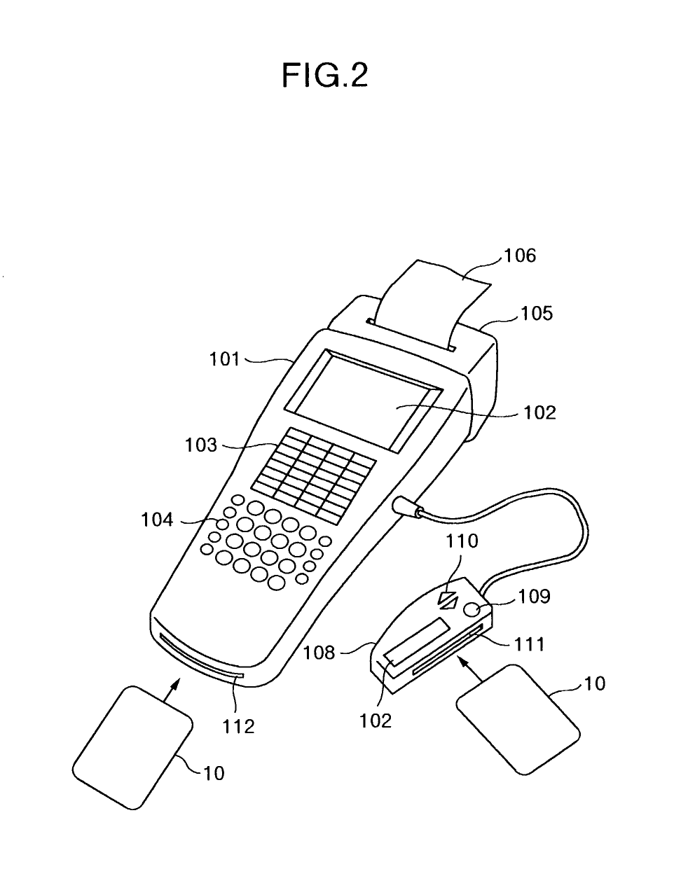

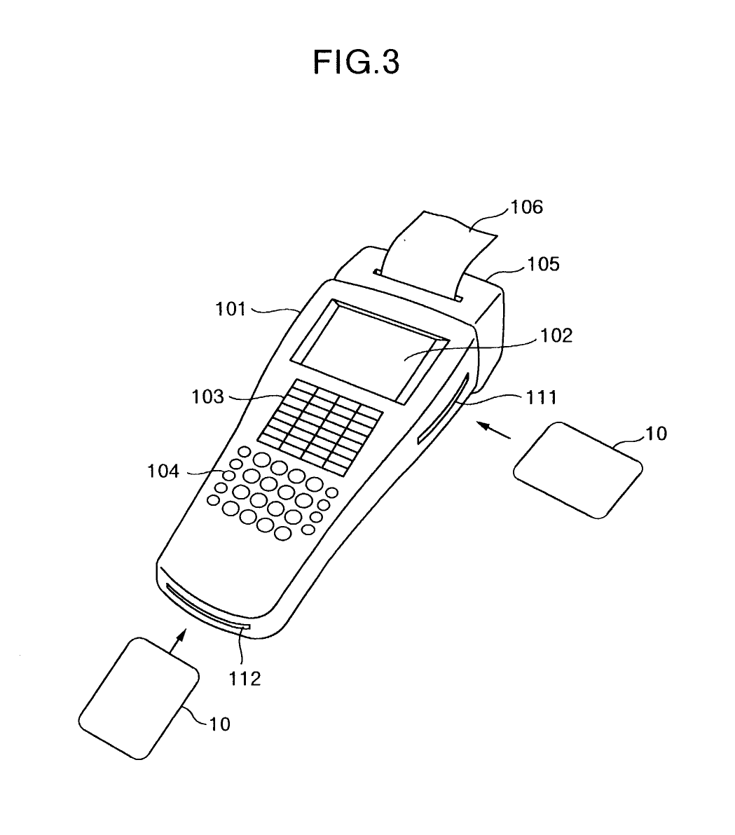

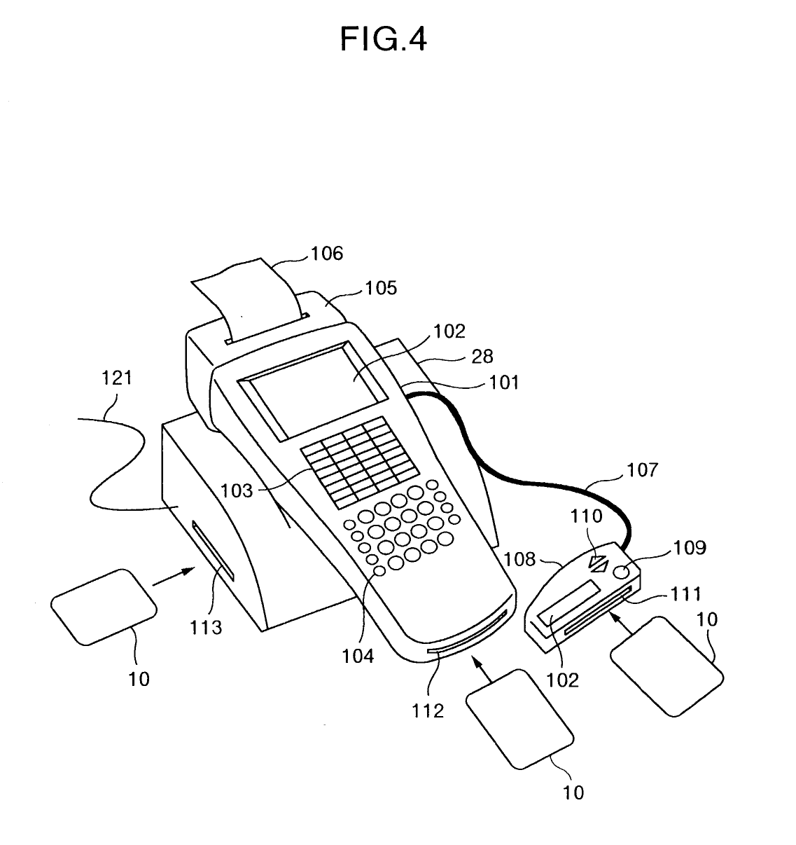

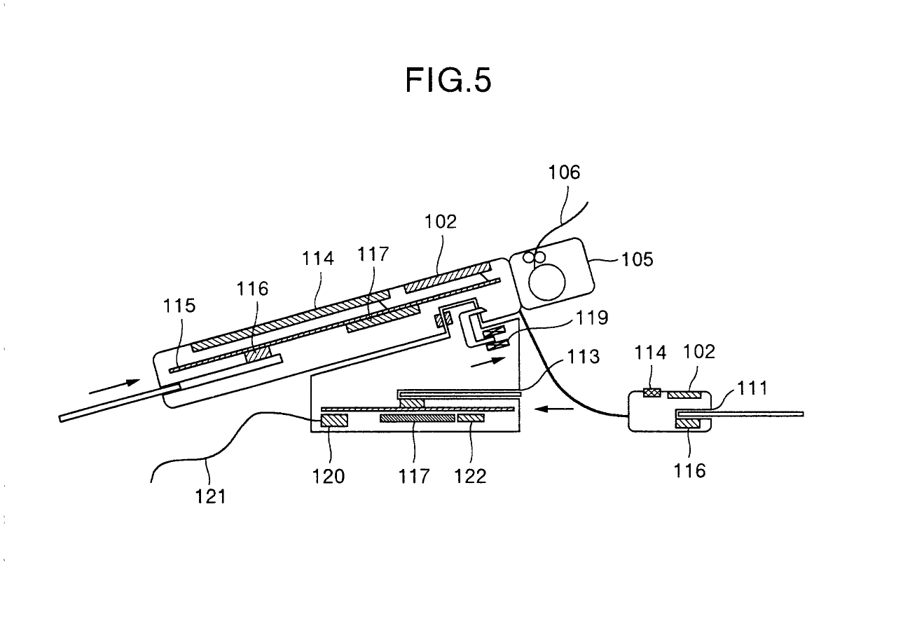

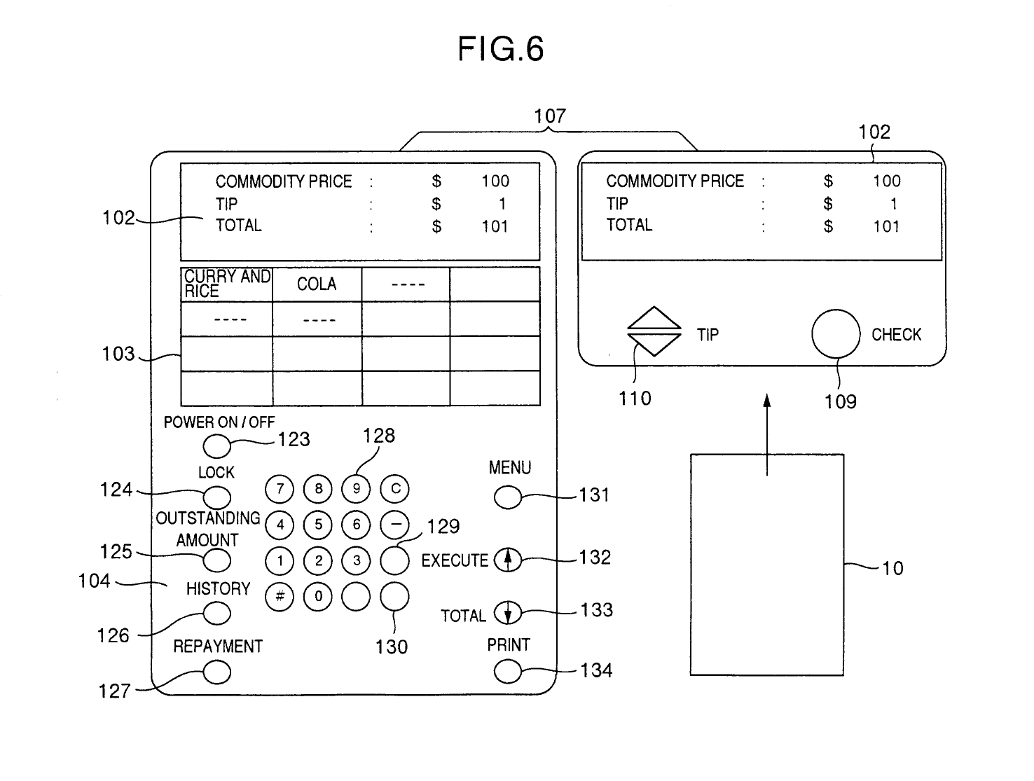

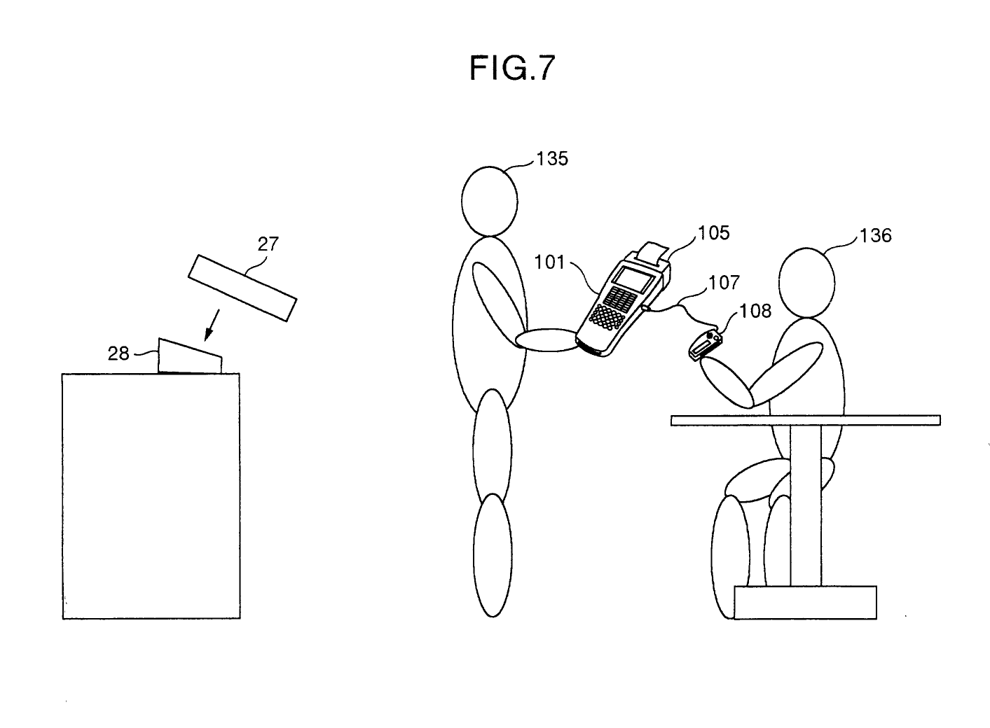

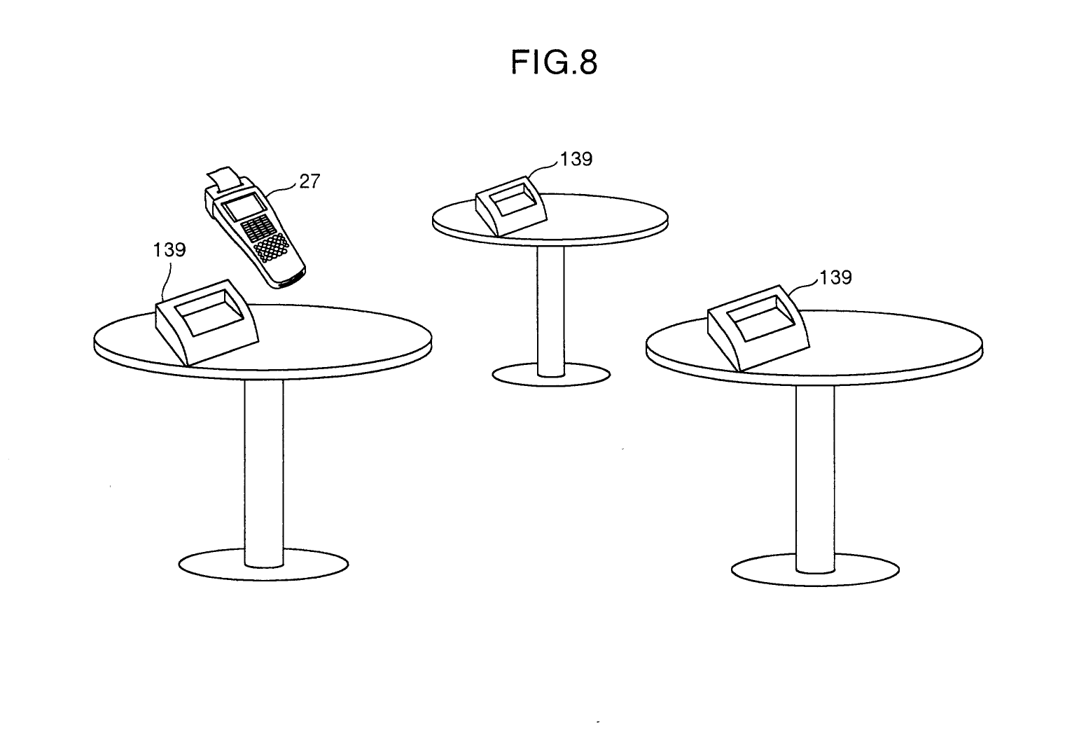

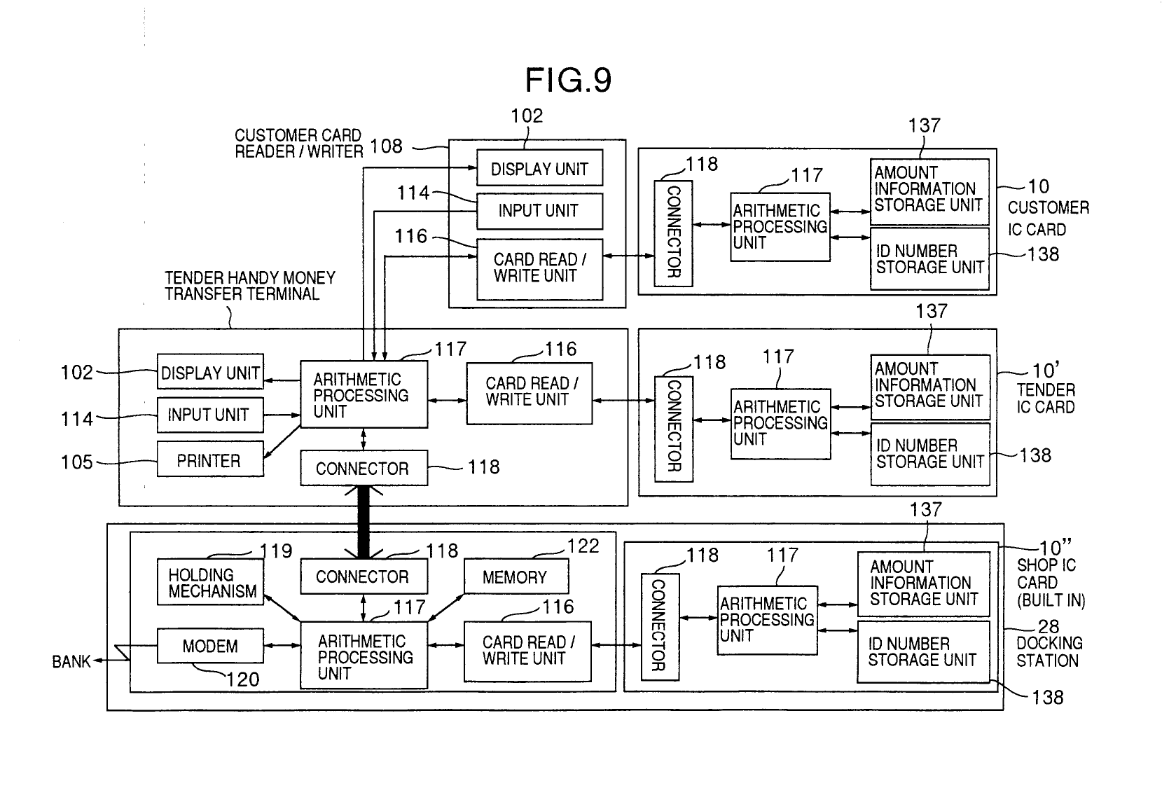

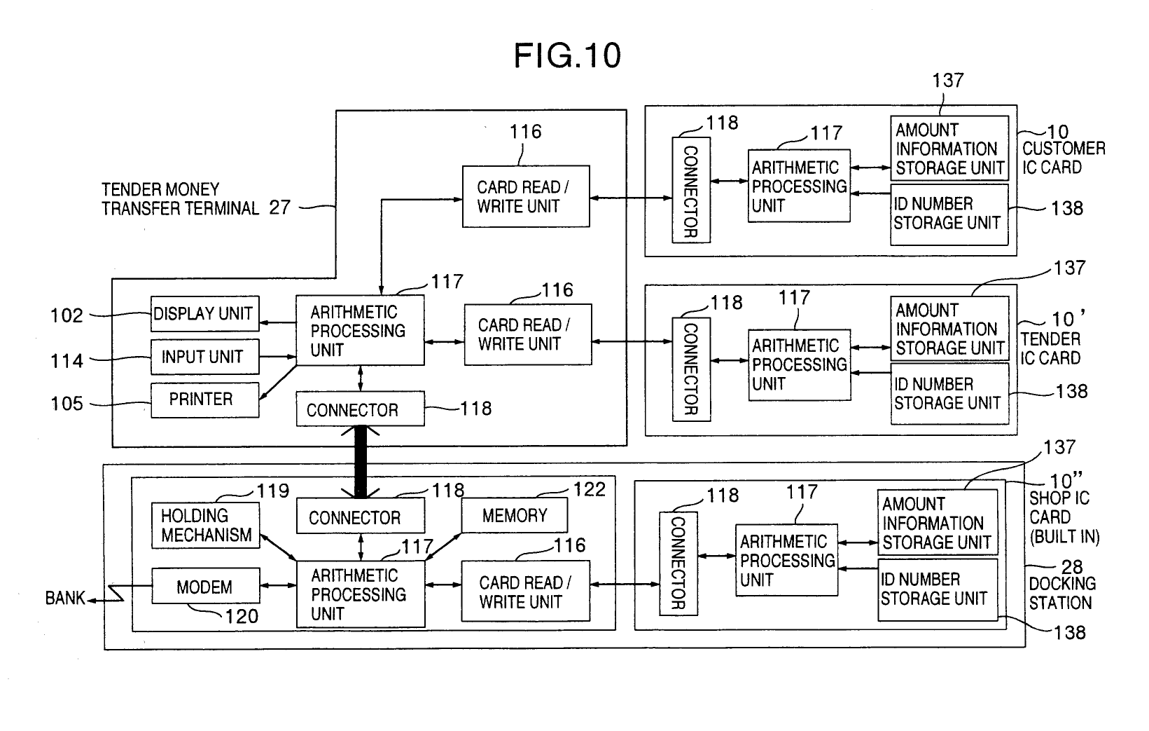

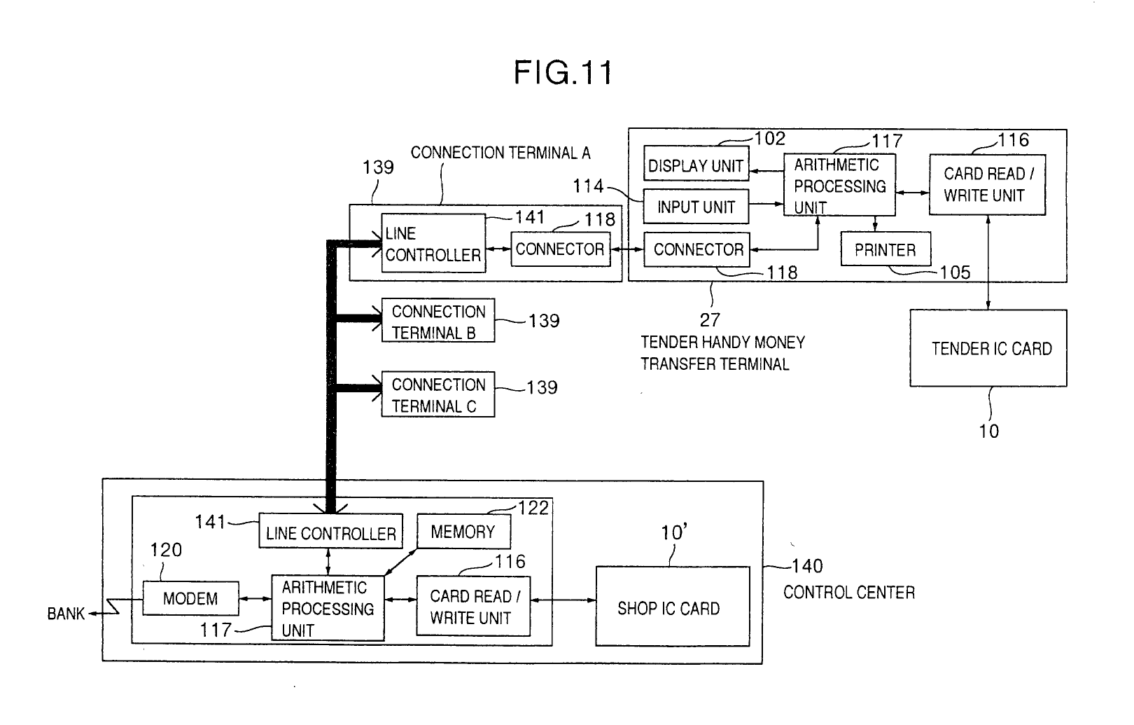

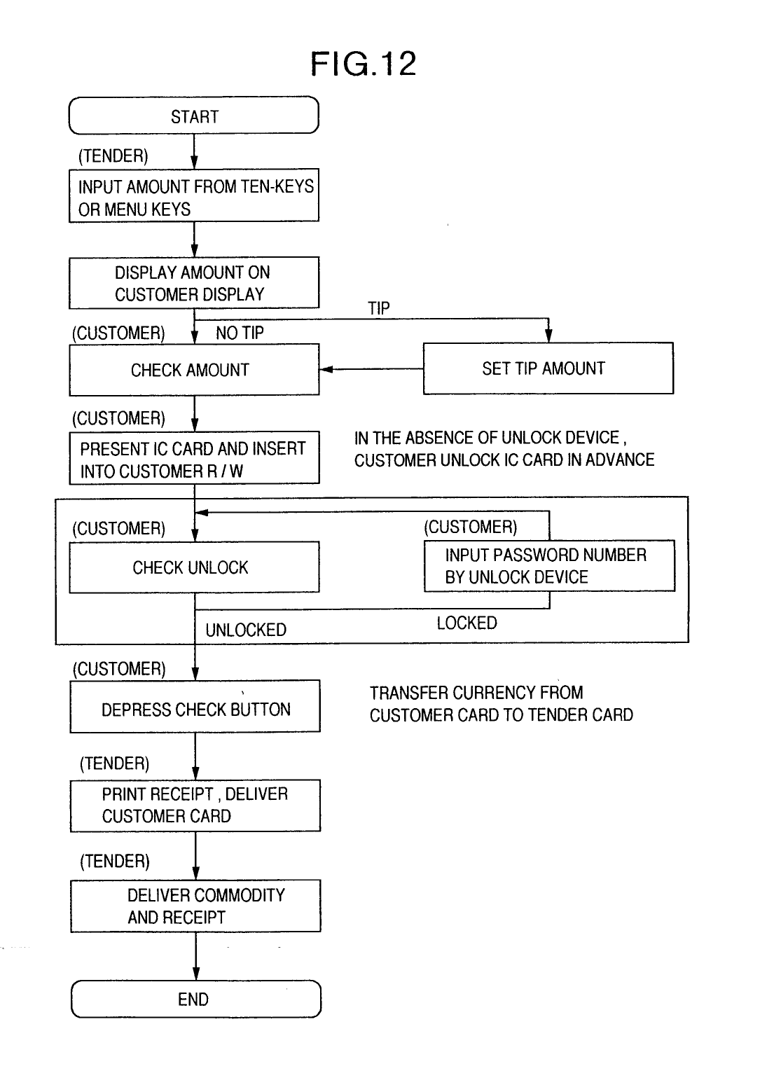

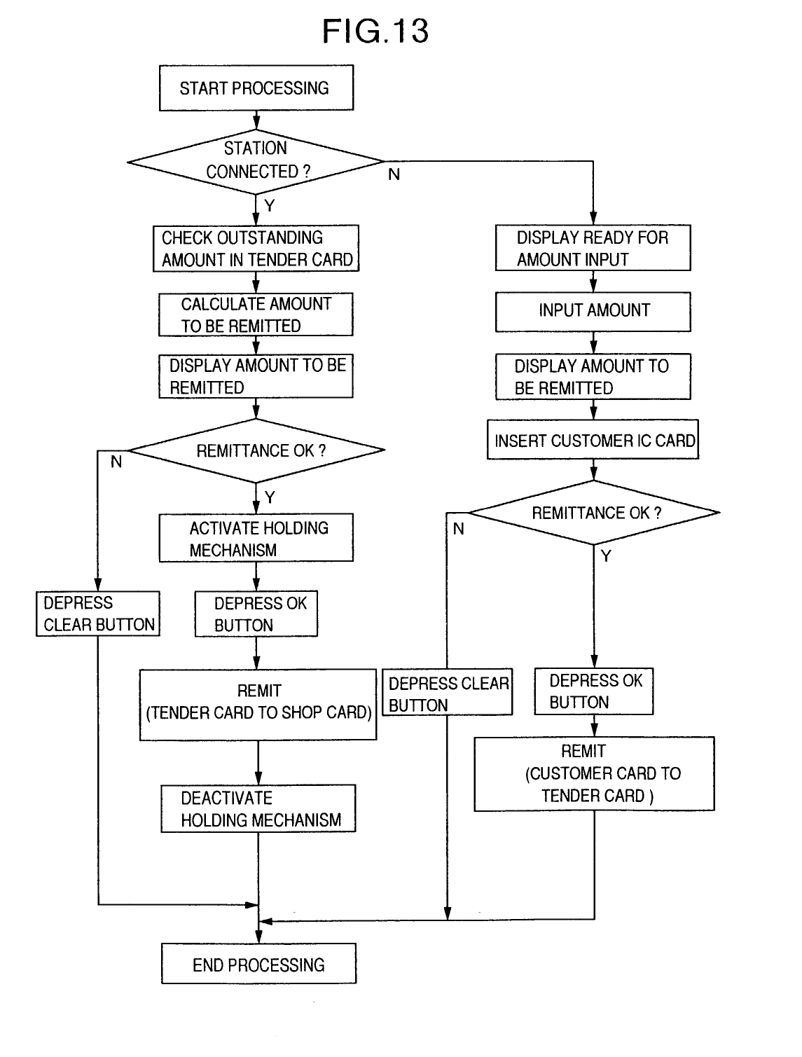

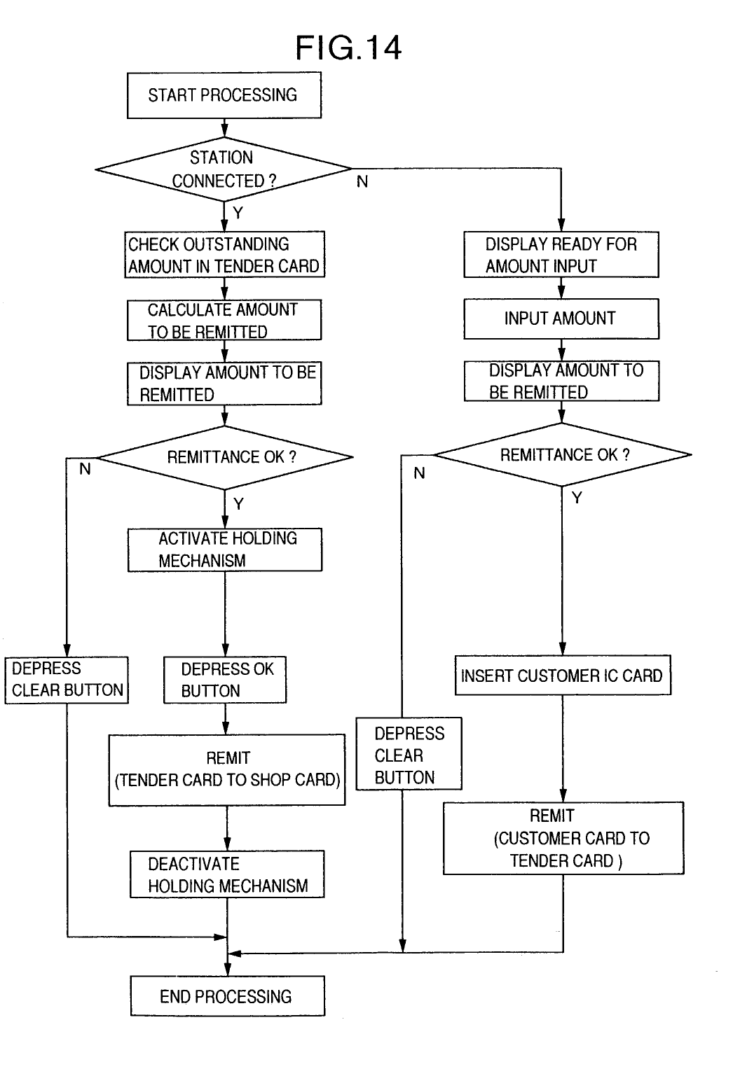

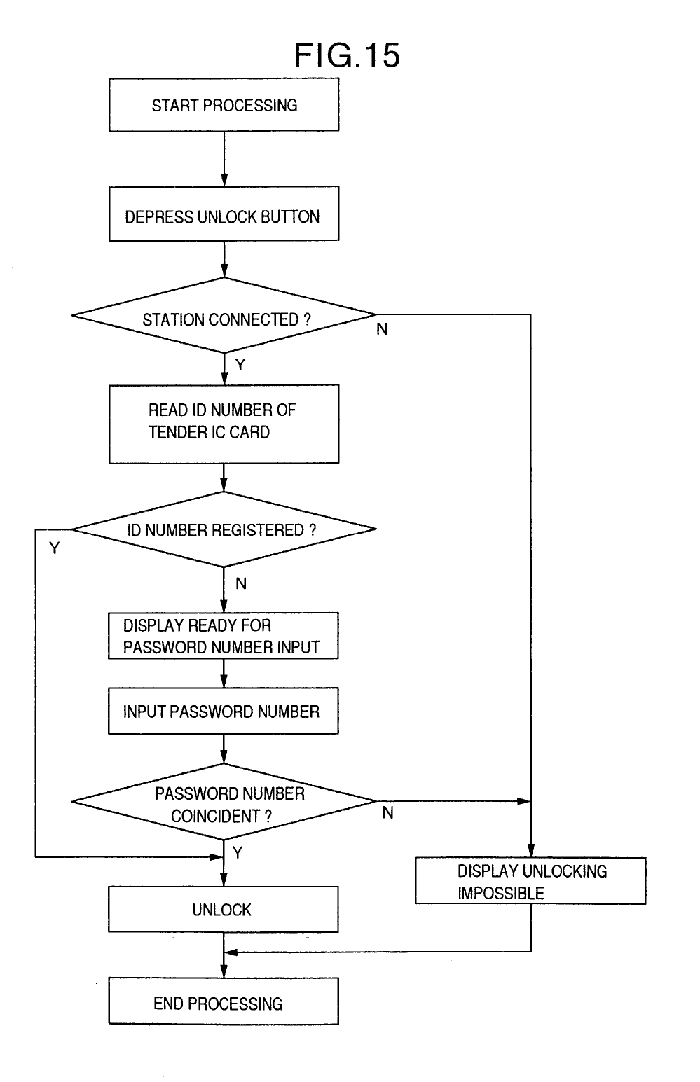

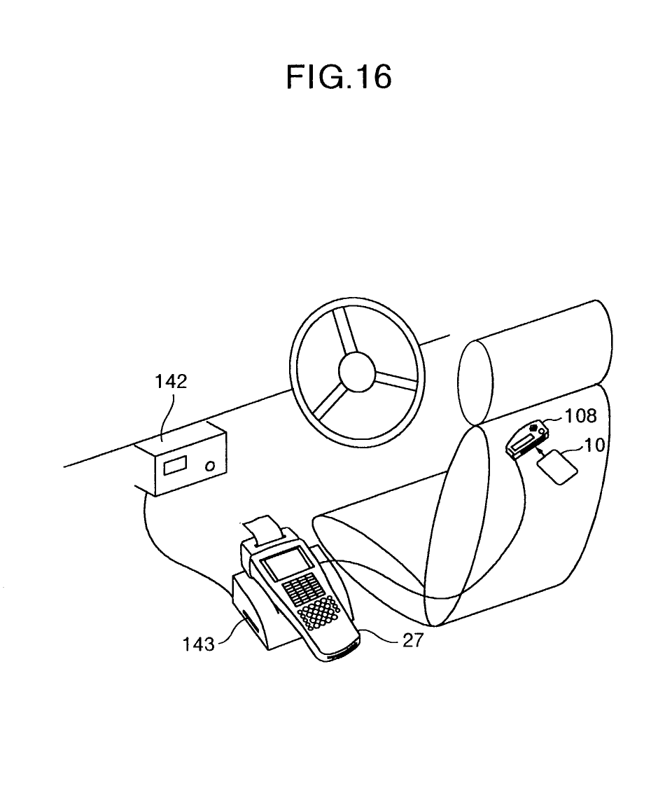

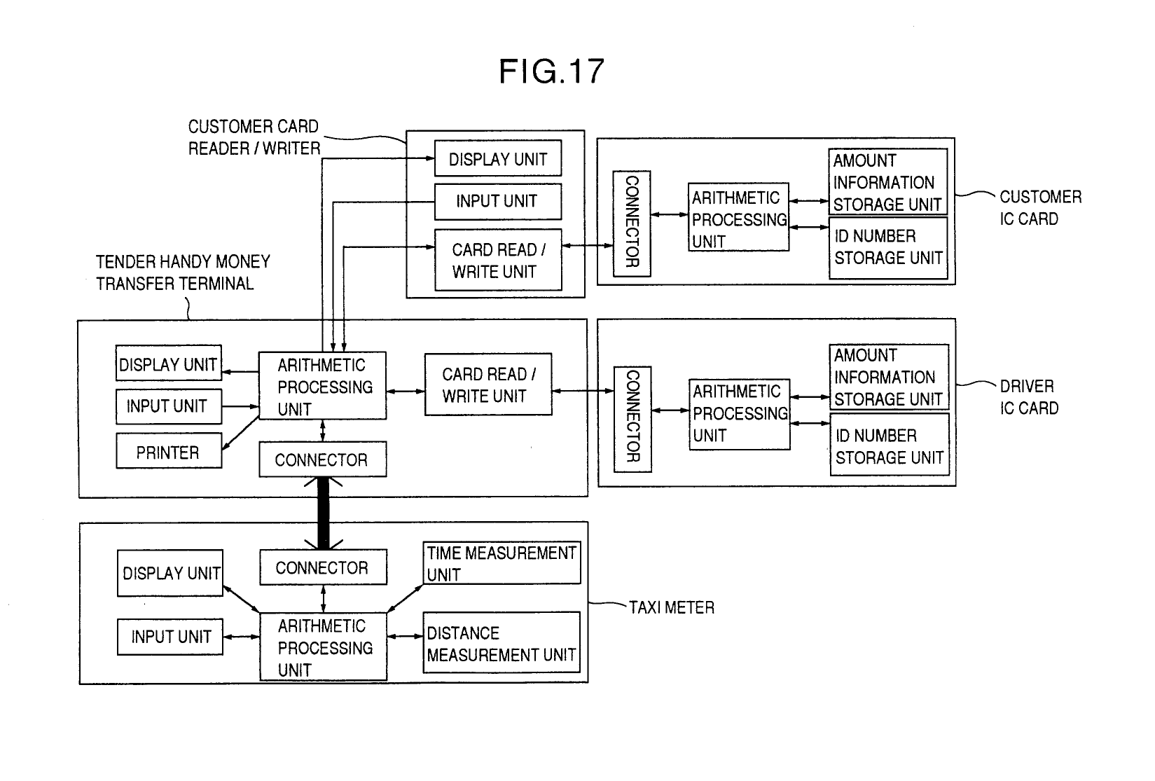

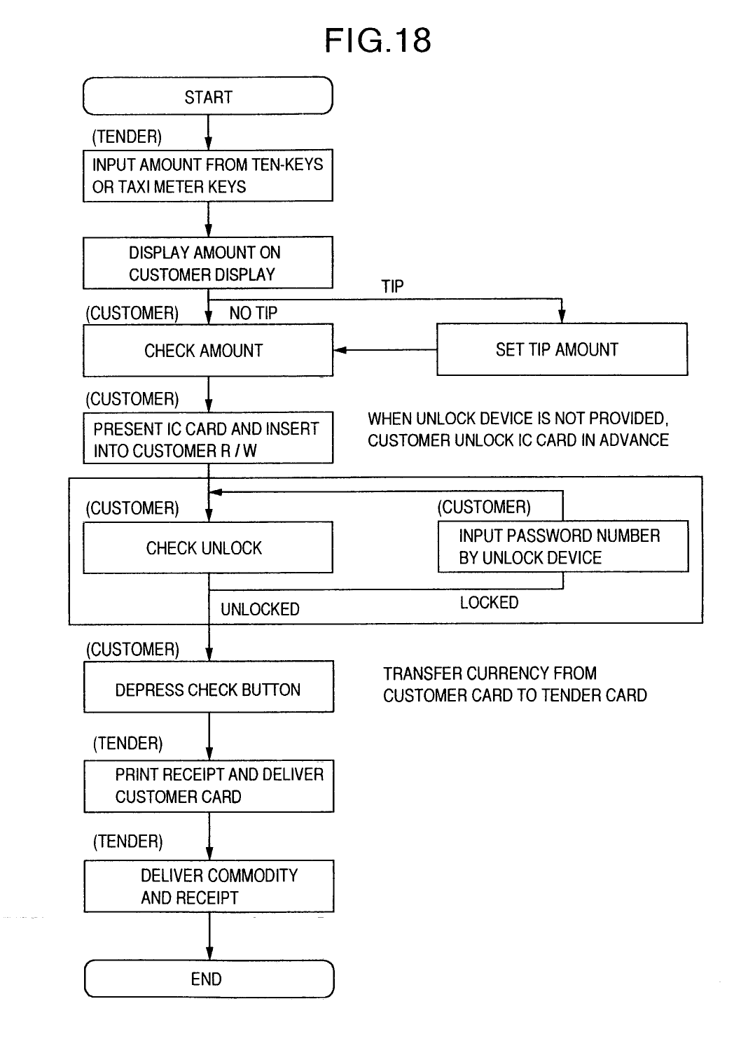

FIG. 1 is a block diagram showing a configuration of an electronic currency system employing the IC card reader/writer according to this invention. With reference to FIG. 1, a configuration of the electronic currency system will be explained.

In FIG. 1, numeral 1 designates a bank branch system, 2 a distribution system, 3 an end user system, 5 a bank computer center, 6 an electronic currency issue organization, 7 a public telephone network, 10 IC cards, 11 an external IC card reader/writer, 12 window terminals, 13 an internal communication line, 14 a cash dispenser, 15 an electronic safe, 16 an electronic currency transaction control terminal, 17 relay computers, 21 an electronic currency POS terminal, 22 a POS terminal, 23 a store controller, 24 a center unit, 25 an information control system, 26 a work station, 27 a portable money transfer terminal (hereinafter sometimes referred to as the handy money transfer terminal), 28 a docking station, 31 an electronic purse, 32 a personal computer, 33 a PC card-type card reader/writer, 34 an IC card telephone, 51 an accounting system host, 52 an external interface system, and 53 an external interface system control terminal.

The electronic currency system shown in FIG. 1 is configured of a public telephone network 7 connected with the bank branch system 1, the distribution system 2 installed in a shop like a retail store, a restaurant or a service provider, the personal computer 2 as an end user system, an IC card telephone 34 and the like. In the shown example, one each representative system is shown. As an alternative, a multiplicity of systems may be connected to the public telephone network 7. Also, the bank branch system is connected to the bank computer center 5 through a dedicated line, and the bank computer center 5 is connected to the electronic currency issue organization 6.

Each IC card 10 includes therein a microprocessor having the communication function and a memory such as an EEPROM for storing a processing program and the outstanding amount of the electronic currency. The IC card 10 is held by an end user or a private person on the one hand and by a bank, a shop or the like participating in the electronic currency system on the other hand.

The bank branch system 1 is connected to the window terminals 12 and the cash dispenser 14 through the internal communication line 13, and further connected to the bank computer center 5 through the relay computer 17. For payment of the electronic currency, each window terminal 12 is provided with the IC card reader/writer 11, and the cash dispenser 14 has built therein an IC card reader/writer. Also, the cash dispenser 14 is connected with the electronic safe 15 through an electronic currency transaction control terminal.

The bank computer center 5 is configured of the accounting system host 51 and the external interface system 52, which in turn includes the external system control terminal 53, the relay computer 17 and the electronic safe 15.

The distribution system 2 normally includes a POS terminal connected to the center unit 24 through the internal communication line 13 and the store controller 23. For payment of the electronic currency, however, the normal POS terminal includes an external IC card reader/writer 11 or an electronic currency POS terminal 21. Also, the center unit 24 includes an information control system 25, a work station 26 and an electronic safe 15.

The end user system 3 primarily constitutes a private user system, which simply may be an electronic purse capable of displaying the outstanding amount of the electronic currency in the IC card. The electronic purse 31 may have also the function of a desktop electronic calculator. Also, the personal computer 32 is owned by a private person and includes a PC-type card reader/writer 33 for electronic currency payment which is connectable with the public telephone line 7. Also, the IC card telephone 34 having the function of processing the IC card 10 containing the electronic currency can be used as a normal telephone.

The personal computer 32 and the IC card telephone set 34 of the end user system 3, by incorporating two card reader/writers for two IC cards therein, can conduct electronic currency transactions between the two IC cards. As a result, the electronic currency in the IC card owned by a husband, for example, can be transferred to the IC card of his/her wife, for example, or otherwise transactions similar to the normal cash transactions can be conducted.

Now, an explanation will be given of a method of using the electronic currency system to which the present invention configured as described above is applicable.

The IC card 10 is distributed from the electronic currency issue organization 6 to the banks, shops, vending machines, private persons, etc. participating in the system. The banks receive the electronic currency in exchange for the cash in normal currency and store it in the electronic safe 15 included in the external interface system 52. The electronic safe 15, as described later, has stored therein a multiplicity of IC cards 10, each of which has stored therein the electronic currency distributed thereto and received thereby from the electronic currency issue organization. The electronic currency stored in the IC card in the electronic safe 15 of the external interface system 52 is distributed among the IC cards 10 in the electronic safe 15 of the bank branch system 1 installed in each bank branch.

A private person or an end user participating in the electronic currency system holds the IC card 10 distributed to him/her, converts the deposit on his/her account maintained in his/her bank into the electronic currency and withdraws it by way of the window terminal 12 or the cash dispenser 14 of the bank branch system 1, and stores it in his/her IC card 10. Also, the personal computer 32 having the PC card-type reader/writer 33 or the IC card telephone 34 is connected to the bank branch system 1 through the public telephone network 7, and as in the case described above, the deposit on his/her account maintained in the bank is converted into the electronic currency and withdrawn and can be stored in his/her IC card 10.

In withdrawing the electronic currency, the IC card held by the private person, due to the communication function contained in the particular card, is connected to the IC card in the electronic safe 15 in the bank branch system 1 through the reader/writer of the window terminal 12, the cash dispenser 14, the personal computer 32 or the IC card telephone 34. Under the control of the electronic currency transaction control terminal 16, the electronic currency stored in the IC card 10 in electronic safe 15 in the bank branch system 1 is stored in the IC card 10 held by the private person. In the process, the outstanding amount of the electronic currency stored in the IC card 10 in the electronic safe 15 in the bank branch system 1 is reduced by the amount stored in the IC card 10 held by the private person. Also, the withdrawal from the account of the private person can be accomplished in a way similar to the conventional method.

The foregoing description refers to the case in which a private person withdraws his/her deposit on his/her bank account and stores it in the IC card held by him/her. Alternatively, the person may bring the cash to the bank window or the window of the electronic currency issue organization and can have it stored in the IC card.

Conversely, the electronic currency in the IC card can be repaid into the IC card in the electronic safe 15 in the bank branch system 1 through the window terminal 12, the cash dispenser 14 and the personal computer 32, while at the same time depositing it in his/her account.

As described above, the user who has stored the electronic currency in his/her IC card can purchase commodities in various shops, etc. and can receive various services using the IC card in the same manner as if he/she pays cash.

Assume that the user that has stored the electronic currency in his/her IC card 10 purchases a commodity in a shop and has brought the commodity to the counter of the POS terminal for payment. The shop tender inputs the sales price of the commodity by way of the POS terminal 21 or 22 by having it read the bar code or the like and calculate the total amount, and claims it from the customer as in the ordinary transactions.

In the case where the customer pays the charge by the IC card containing the electronic currency instead of in cash, the customer inserts the IC card in the card insertion hole of the electronic currency POS terminal 21 or the IC card reader/writer 11 connected to the ordinary POS terminal 22. As a result, the IC card of the customer is connected to one of the IC cards in the electronic safe 15 installed in the center unit 24 of the shop through the internal communication line 13 and the work station 26, so that the electronic currency in the customer's IC card is transferred to the particular one of the IC cards in the electronic safe 15 installed in the center unit 24. Thus, the receipt is output from the POS terminal and the payment of the price of the purchased commodity is completed. In this case, the electronic currency in the customer's IC card is reduced by the amount expended for the commodity, which amount is added to the electronic currency in the IC card of the particular shop.

The foregoing description assumes that the commodity price is paid in a distribution system including a multiplicity of POS terminals and an electronic safe with a multiplicity of IC cards stored in the center unit 24. In a system used in a mom-and-pop shop or the like having only one cash register, however, the cash register includes an IC card reader/writer for customers' IC cards, and the IC card of the particular shop is built in the cash register. In this way, transactions in electronic currency are possible between the IC card held by the particular shop and the customer's IC cards connected to the shop IC card held through the IC card reader/writer. The electronic currency in the IC card held by the shop can be paid in a bank account or encashed at the bank window as described above, as described above.

Further, in a distribution system having the POS terminal described above, a system can be constructed by a method in which each POS terminal is caused to hold an IC card, the money transactions with the customer's IC card are conducted temporarily between the IC card in the POS terminal and the customer's IC card, and when required, the account is transferred from the POS terminal to the IC card in the electronic safe 15 of the center unit 24.

Now, an embodiment of the portable money transfer terminal according to this invention used for the electronic currency system described above will be explained with reference to the drawings.

FIG. 2 is a perspective view showing the outer appearance of a portable money transfer terminal according to an embodiment of the invention. In FIG. 2, numeral 101 designates a body, 102 a display unit, 103 commodity/menu keys, 104 ten-keys and function keys, 105 a printer, 106 a receipt, 107 a cable, 108 an IC card reader/writer, 109 a check button, 110 tip buttons, 111 a customer IC card insertion hole and 112 an shop tender IC card insertion hole.

FIG. 3 is a perspective view showing the outer appearance of a portable money transfer terminal according to another embodiment of the invention.

FIG. 4 is a perspective view showing the portable money transfer terminal according to an embodiment of the invention set in a docking station. In FIG. 4, numeral 113 designates a shop IC card insertion hole.

FIG. 5 is a sectional view showing a portable money transfer terminal according to an embodiment of the invention set in a docking station.

In FIG. 5, numeral 114 designates an input unit including commodity/menu buttons, ten-keys and a tip button, 115 a printed board, 116 an IC card reader/writer, 117 an arithmetic processing unit, 118 a connector, 119 a holding mechanism, 120 a communication modem, 121 a cable connected to the public telephone line or LAN, and 122 a memory.

FIG. 6 is a diagram showing the display unit and the input unit of a portable money transfer terminal according to an embodiment of this invention. In FIG. 6, 123 designates a power on/off button, 124 a lock button, 125 a button for displaying the outstanding amount, 126 a history display button, 127 a repayment button, 128 ten-keys, 129 an execution button, 130 a total button, 131 a menu button, 132 an increment key, 133 a decrement key, and 134 a print button.

FIGS. 7 and 8 are diagrams showing the manner in which the portable money transfer terminal according to an embodiment of this invention is used in a shop. In FIG. 7, numeral 135 designates a shop tender and 136 a customer. In FIG. 8, numeral 139 designates a connection terminal.

A portable money transfer terminal 27 according to an embodiment of this invention includes, as shown in FIG. 2, a body 101, a printer 105, and an IC card reader/writer 108 separated from the body and communicable with the body through a cable 107 or the like. The body 101 includes a display unit 102, commodity/menu keys 103 for inputting commodities purchased by customers and menu, ten-keys and function keys 104, and an shop tender IC card insertion hole 112 in which a shop tender attending a customer inserts an IC card. Further, a printer 105 for printing a receipt 106 is connected. Also, the customer IC card reader/writer 108 separated from the body includes a display unit 102, a check button 109 for checking and settling the amount paid by the customer, and a tip button 110 for determining the amount of the tip to be paid to the shop tender.

FIG. 3 shows an example of the case having no IC card reader/writer separate from the body. The customer IC card insertion hole 111 is formed in the side of the body. In this case, the functions of the display button 102, the check button 109 and the tip button 110 included in the IC card reader/writer 108 shown are performed by the display unit 102 and the function keys 104 arranged on the body. With this configuration, the portable money transfer terminal can be rendered more compact and easier to carry.

As shown in FIG. 4, with the portable money transfer terminal set in the docking station, the electronic currency transactions can be carried out between the IC card inserted from the shop tender IC card insertion hole 112 or the IC card inserted from the customer IC card insertion hole 111 and the IC card inserted from the shop IC card insertion hole 113. Also, the electronic currency stored in the shop IC card can be transferred to the IC card in the electronic safe or can be deposited in an bank account through a cable 121 connected to the public telephone line or LAN.

A sectional view of the portable transfer terminal set in the docking station is shown in FIG. 5. The information in the IC card inserted from the shop tender IC card insertion hole 112 is read by the card read/write unit 116, calculated by the arithmetic processing unit 117 and transmitted to the docking station through the connector 118. In the docking station, the information received is processed in the arithmetic processing unit 117 and written in the IC card inserted in the shop IC card insertion hole 113 by the card read/write unit 116. Also, exactly the opposite operation can be performed. That is, the information in the IC card inserted in the shop IC card insertion hole 113 is read and written in the IC card inserted in the shop tender IC card insertion hole 112. Also, by connecting to the public telephone line or the LAN through the modem 120 and the cable 121, the electronic currency stored in the IC card can be remitted to a bank account or the IC card in the electronic safe. Further, the history of transactions of the electronic currency is recorded in the memory 122.

As long as the electronic currency transactions are being conducted with the portable money transfer terminal set in the docking station, the holding mechanism 119 is operated to hold the portable money transfer terminal in connection with the docking station. This is in order to prevent the set in communication from coming off under a shock or the like and causing a communication failure.

Assuming that the portable money transfer terminal is set in the docking station and repayment to the customer is desired, for example, the corresponding electronic currency transactions can be conducted between the IC card inserted in the shop IC card insertion hole 113 and the IC card inserted in the customer IC card insertion hole 111.

The display unit 102 and the input unit 114 of the portable money transfer terminal and the customer IC card reader/writer are configured as shown in FIG. 6. The commodity/menu keys 103 of the terminal used in restaurants, for example, display the menu handled by a particular restaurant such as curry rice and cola. The shop tender inputs the order received from the customer by way of these keys. In the case where the terminal is equipped with the radio communication function, each order can be transmitted to the kitchen by radio. In settling the account, the total amount of the ordered items of menu (commodities) and the tip amount is displayed on the display unit 102. Similar information are also displayed on the display unit 102 of the customer card reader/writer. In the shown example, a predetermined amount of the tip is displayed. The customer operates the tip button 110 of the customer IC card reader to increase or decrease the tip amount, as the case may be. As an alternative, buttons indicating 10%, 15%, etc. are arranged on the customer IC card reader, and the customer selectively depresses any one of the buttons thereby to determine the tip amount. The tip amount is to be determined by the customer. Therefore, in the case where the chip buttons are arranged on the customer IC card reader/writer separated from the body, the customer can easily input the tip amount and the customer labor is saved while at the same time improving the feel of satisfaction. For those shops requiring no tip, the tip display and the chip buttons are not required. Also, taxes or the like can be displayed. Further, different items can be displayed on the display unit 102 of the terminal and the customer IC card reader.

The portable money transfer terminal and the docking station are used in restaurants, etc. for example, in the form as shown in FIG. 7. The shop tender 135 carries at least the body 101 of the terminal, receives an order from the customer 136, receives the commodity price in electronic currency from the customer 136, or by connecting the terminal to the docking station 28, transfers the electronic currency stored in the IC card of the terminal to the IC card of the docking station. The customer 136, when paying the price of a commodity, inserts his/her IC card in the customer IC card reader/writer 108, checks the amount displayed and settles the account by electronic currency by operating the check button, etc. The customer card reader/writer 108 can be carried by the shop tender while being connected to the terminal, or can be installed on the customer table or the like ready for connection with the terminal whenever required. Also, the printer 105 for printing the receipt can be connected either to the terminal body 101 or to the docking station 28.

As shown in FIG. 8, a plurality of connection terminals 139 are installed at a plurality of points in the shop, and by setting the portable money transfer terminal in any one of the connection terminals, the electronic currency stored in the IC card in the portable money transfer terminal can be transferred to the shop IC card in a control center described later. The control center, which is connected to the public telephone line or a LAN, can remit the electronic currency to a bank or store it in an electronic safe efficiently. In this way, the electronic currency can be remitted or stored efficiently in the case where a shop has many tenders or a wide space. Also, the number of the portable money transfer terminals and the number of the docking stations or the connection terminals are not necessarily in one-to-one relation, but the portable money transfer terminals may be greater in number, or the other way around. The provision of more portable money transfer terminals is effective primarily for a shop having many shop tenders, while the provision of more docking stations or more connection terminals is effective primarily for a shop having a wide space.

FIG. 9 is a block diagram showing a functional configuration of the portable money transfer terminal and the docking station shown in FIG. 4. Numeral 137 designates an amount information storage unit, and 138 an ID number storage unit. Other reference numerals designate similar components to those shown in FIGS. 1 to 8, respectively.

FIG. 10 is a block diagram showing a functional configuration of the portable money transfer terminal of FIG. 3 set in a docking station. The reference numerals designate similar component parts to those in FIGS. 1 to 9, respectively.

FIG. 11 is a block diagram showing a functional configuration of the portable money transfer terminal set in the connection terminal 139 of FIG. 8. Numeral 140 designates a control center, and 141 a line controller. Other reference numerals are similar to those in FIGS. 1 to 10, respectively.

Now, an explanation will be given of an example operation for transactions of the electronic currency in the IC cards using the portable money transfer terminal configured as described above.

FIG. 12 is a flowchart of the electronic currency transactions conducted between the shop tender IC card and the customer IC card using the portable money transfer terminal according to an embodiment of the present invention. An explanation will be given below with reference to the same flowchart.

First, a power button 123 is depressed to switch on power and start the operation. The tender manipulates ten-keys 128 or commodity/menu keys thereby to input the amount of a customer order and a purchased commodity. Then, the amount is displayed on the display unit 102 of the portable money transfer terminal and the customer IC card reader/writer. In the case where the tip is paid, the customer sets the amount of the tip by operating the tip button 110 of the customer IC card reader/writer. The amount including the tip is checked and the IC card is inserted into the customer IC card insertion hole 111. The customer checks whether the customer IC card is unlocked or not. In the case where the customer IC card is not unlocked, the password number is input into an unlocking device included in the portable money transfer terminal or installed as a separate unit such as an electronic purse thereby to unlock the customer IC card. After that, the customer depresses the check button 109, so that the electronic currency of an amount displayed on the display unit 102 is transferred to the shop tender IC card from the customer IC card. The tender prints a receipt 106 in a printer 105 while at the same time delivering and returning the customer IC card. Further, the printed receipt and the commodity are delivered to the customer. In the case of a restaurant, the commodity, that is, the food may have already been served to the customer. In that case, the power button 123 is turned off to end the operation.

FIG. 13 is a flowchart showing the case in which electronic currency transactions are conducted between the shop tender IC card and the shop IC card using the portable money transfer terminal and the docking terminal according to an embodiment of the invention. The explanation will be given below with reference to this flowchart.

The portable money transfer terminal is powered on and connected to the docking station. The outstanding amount of the shop tender IC card is checked, and the amount to be remitted to the shop IC card excluding the tip is calculated. The tip amount is recorded separately from the amount to be remitted to the shop IC card and the amount to be remitted to the shop IC card is remitted to the shop IC card, while the tip is left in the tender IC card. The IC card may include several pockets for storing the electronic currency in several parts. The proceeds of the shop and the tip to the tender can thus be stored in different pockets. Since the amount remitted is displayed, the tender can determine whether the remittance is OK or not, and if OK, depresses the OK button, otherwise he/she depresses the clear button. Once the OK button is depressed, the electronic currency is remitted from the tender IC card to the shop IC card. In the process, a holding mechanism 119 is operated to make sure that the portable money transfer terminal and the docking station are not disconnected from each other at the time of remittance. The timing of operating this holding mechanism can be either before or after the depression of the OK button. After the remittance ends, the holding mechanism 119 is turned off and the process ends. At the same time, the electronic currency stored in the shop IC card can be automatically remitted to a bank, an electronic safe or the like through the public telephone network or the LAN. It is also possible to remit the electronic currency directly to the bank or the electronic safe without going through the shop IC card. In that case, the shop IC card insertion hole and the card reader/writer are eliminated, and the system can be simplified. In the case where the portable money transfer terminal is not connected to the docking station, on the other hand, as shown to the right in FIG. 13, the electronic currency is remitted from the customer IC card to the tender IC card. The steps of this remittance are similar to those explained above with reference to the flowchart of FIG. 12.

FIG. 14 is a flowchart showing the case in which the electronic currency transactions are conducted between the tender IC card and the shop IC card or between the customer IC card and the tender IC card using the portable money transfer terminal and the docking terminal according to an embodiment of the present invention in a manner similar to FIG. 13. This will be explained below.

In the case explained with reference to FIG. 12 where the electronic currency is remitted from the customer IC card to the tender IC card, the amount to be remitted on display is checked, and then the OK button is depressed. As an alternative method, the operation of depressing the OK button can be replaced with the operation of inserting the customer IC card into the customer IC card insertion hole. Specifically, as its flow is shown to the right of FIG. 14, after checking the displayed amount to be remitted, the customer IC card is inserted if the remittance is OK, and otherwise the clear button is depressed. The other steps of operation are similar to those of FIG. 13. This method can be employed also when using the portable money transfer terminal having no separate customer IC card reader/writer as shown in FIG. 3. Since the operation can be reduced by one stage, the electronic currency transactions can be accomplished with a short, time. The check button 109 is not required also in the case where the separate customer IC card reader/writer is included in the system, and therefore the system can be simplified while at the same time reducing the cost. Also, since the operation can be reduced by one stage, the electronic currency transactions can be performed within a short time.

As shown in FIGS. 13 and 14, the direction of remittance of the electronic currency is restricted depending on whether the portable money transfer terminal is connected to the docking station or not. Specifically, in the case where the portable money transfer terminal is not connected to the docking station, the remittance of the electronic currency only in the direction from the customer IC card to the tender IC card is permitted. In the case where the portable money transfer terminal is connected to the docking station, on the other hand, the remittance of the electronic currency only in the direction from the tender IC card to the shop IC card is permitted. As a result, in the state where the shop IC card is stored in the docking station and the tender IC card is stored in the portable money transfer terminal, the proceeds of the shop can never be moved to the tender card, the customer card or third-party IC cards (except for the case of repayment described later). Also, the electronic currency stored in the tender IC card is never transferred to the customer IC card or third-party IC cards. Thus, the theft or the like of the electronic money is prevented advantageously from the viewpoint of safety.

FIG. 15 is a flowchart showing the case in which the tender IC card is unlocked for conducting electronic currency transactions between the tender IC card and the shop IC card according to an embodiment of the present invention.

Depress a lock button 124 of the portable money transfer terminal having the tender IC card stored therein. In the case where the terminal is connected to the docking station, the card read/write unit 116 reads the ID number of the particular tender IC card. In the case where the ID number is already registered, the tender IC card is unlocked as it is. In the case where the ID number is not registered as yet, the instruction to input the password number is displayed. In the case where the password number is input and coincides, the tender IC card is unlocked. In the case where the password number fails to coincide, on the other hand, the display is made to the effect that the tender IC card cannot be unlocked. Also, in the case where the portable money transfer terminal is not connected to the docking station, it is displayed that the unlocking is impossible. By employing this method, with the tender IC card stored in the portable money transfer terminal, the withdrawal of the electronic currency from the tender IC card is possible only in the case where the docking terminal is connected. Therefore, the tender receiving the customer is prevented from erroneously remitting the electronic currency from the tender IC card to the customer IC card or remitting to other than the shop IC card. Apart from the method shown in the flowchart of FIG. 15, a method can be employed in which when the portable money transfer terminal is connected to the docking station, the tender IC card is unlocked unconditionally. According to this method, the operation of the unlocking button and the operation of inputting the password number can be eliminated. Therefore, the tender IC card can be unlocked within a short time, and rapid electronic currency transactions are made possible. It is also possible to employ a method in which the password number is input without fail at the same time when the portable money transfer terminal is connected to the docking station. According to this method, in the case where a plurality of tenders use a plurality of portable money transfer terminals, for example, the IC card of a tender is not unlocked when the portable money transfer terminal having stored therein the IC card of a different tender is erroneously connected to the docking station. Also in the case where a person other than the tenders connects it, the unlocking is impossible unless he/she knows the password number. For this reason, the unlocking job can be performed carefully and positively with a further improved safety.

FIG. 16 is a diagram showing the manner in which the portable money transfer terminal according to an embodiment of the invention is used in a taxi. In FIG. 16, numeral 142 designates a taxi meter, and 143 a support. The taxi meter 142 is connected to the portable money transfer terminal 27 through the support 143, and a customer IC card reader/writer 108 is installed at a position capable of being operated by the customer. The customer IC card reader/writer 108 can be delivered to the customer only his/her operation is required and may be otherwise arranged in the vicinity of the portable money transfer terminal 27.

FIG. 17 is a block diagram showing a functional configuration of the portable money transfer terminal, the customer IC card reader/writer and the taxi meter shown in FIG. 16. Numeral 144 designates a device for measuring the time taken for covering a given distance, and 145 a device for measuring the distance covered. The other reference numerals are similar to those of FIGS. 1 to 16, respectively.

FIG. 18 is a flowchart showing the case in which the electronic currency transactions are carried out between the taxi driver IC card and the customer IC card using the portable money transfer terminal according to an embodiment of the present invention shown in FIGS. 16 and 17. This will be explained below.

First, a power button 123 is depressed to switch on power and start the operation. The amount is input by the driver operating ten-keys 128 or automatically from the taxi meter 142. Then, the amount is displayed on the display unit 102 of the portable money transfer terminal and the customer IC card reader/writer. In the case where the tip is paid, the customer operates the tip button 110 of the customer IC card reader/writer to set the amount of the tip. The amount including the tip is checked, and the IC card is inserted into the customer IC card insertion hole 111. Then, the customer checks whether the customer IC card is unlocked or not. When the customer IC card is not unlocked, it is unlocked by inputting the password number by an unlocking device included in the portable money transfer terminal or such an unlocking device as an electronic purse separately provided. After that, the customer depresses the check button 109 so that the electronic currency of an amount displayed on the display unit 102 is transferred from the customer IC card to the driver IC card. The driver prints the receipt 106 in the printer 105 and delivers and returns the customer IC card. Further, the printed receipt is delivered to the customer. The power button 123 is turned off to end the operation. The driver, when he/she returns to his/her office after the work, sets the portable money transfer terminal in the docking station installed in the office, and thus remits the electronic currency stored in the driver IC card to the IC card of the taxi company by the method described with reference to FIG. 13.

Also in taxi applications of the portable money transfer terminal according to an embodiment of the invention, the customer IC card reader/writer may not be provided separately as shown in FIG. 3, and any one of the operation methods described above may be used.

### INDUSTRIAL APPLICABILITY

The present invention is applicable to an electronic currency POS terminal used for an electronic currency system, or more in particular to an electronic currency POS terminal installed at such a place as a wide shop or a transportation means where it is often brought in for use.

1. An IC card reader/writer for transferring the electronic currency held in an IC card, comprising:
a body having an insertion hole for inserting said IC card and buttons for inputting an amount; and
a station separated from said body, and with said body set therein, capable of transferring the electronic currency through a communication line.

2. An IC card reader/writer according to claim 1, characterized in that said body has two insertion holes for inserting IC cards.

3. An IC card reader/writer according to claim 1, characterized by further comprising a holding mechanism for holding the state in which said body is set in said station.

4. An IC card reader/writer for transferring the electronic currency held in an IC card, comprising:
a body having an insertion hole for inserting said IC card and buttons for inputting an amount; and
a IC card read/write unit including an insertion hole for inserting an IC card, capable of communicating with said body, and separated from said body; and
a station separated from said body, and with said body set therein, capable of transferring the electronic currency through a communication line.

5. An IC card reader/writer according to claim 4, characterized in that said IC card read/write unit includes buttons for determining the amount of the tip.

6. An IC card reader/writer for transferring the electronic currency held in an IC card, comprising:
an insertion hole for inserting an IC card and buttons for inputting an amount, said IC card reader/writer being usable by being separated from the station connected to a communication line, said IC card reader/writer being capable of transferring the electronic currency through the communication line when set in said station.

7. An IC card reader/writer according to claim 6, characterized by comprising two insertion holes for inserting IC cards.

8. An IC card reader/writer according to claim 6, characterized by comprising an IC card read/write unit communicable with an IC card reader/writer according to claim 6, separated from said IC card reader/writer and including an insertion hole for inserting an IC card.

9. A method of operating an IC card reader/writer for transferring the electronic currency held in an IC card, comprising the steps of:
inputting an amount from the body of said IC card reader/writer;
displaying said amount on an IC card read/write unit communicable with said body and separated from said body; and
inserting an IC card into the IC card insertion hole of said IC card read/write unit.

10. A method of operating an IC card reader/writer according to claim 9, characterized by further comprising the step of inputting the amount of the tip using the buttons of said body or said IC card read/write unit.

11. A method of operating an IC card reader/writer for transferring the electronic currency held in an IC card, characterized by the steps of:
setting the body of said IC card reader/writer in a station separated from said body and capable of transferring the electronic currency through a communication line when said body is set in said station; and
displaying the amount remitted from the IC card inserted in the body to the IC card inserted in said station or to another electronic currency holding means for transferring the electronic currency through said communication line.

12. A method of operating an IC card reader/writer according to claim 12, characterized by comprising the step of operating the holding mechanism for holding the set state of said station and said body.

13. A method of operating an IC card reader/writer according to claim 11, characterized by comprising the step of unlocking the IC card inserted into said body in the set state of said station and said body.
